(19) United States
(12) Patent Application Publication
(10) Pub. No.: US 2016/0174305 A1
(43) Pub. Date: Jun. 16, 2016

(54) AC LED LUMINESCENT APPARATUS AND A DRIVING METHOD THEREOF

(71) Applicant: POSCO LED COMPANY LTD., Seongnam-si (KR)

(72) Inventors: Dae Won Kim, Seongnam-si (KR); Seong-Bok Yoon, Seongnam-si (KR)

(21) Appl. No.: 14/569,279

(22) Filed: Dec. 12, 2014

(51) Int. Cl. H05B 33/08

(52) U.S. Cl. CPC H05B 33/083; H05B 33/0809

(57) ABSTRACT

An alternating current (AC) light emitting diode (LED) luminescent apparatus includes: a rectification unit configured to: receive an AC input; and output, via full-wave rectification, a rectified voltage; light emitting groups configured to sequentially receive the rectified voltage in associated with corresponding emission periods; light emitting group driving units configured to respectively control current applied to the light emitting groups; and an LED driving integrated circuit configured to sequentially operate the light emitting groups based on voltage levels of the rectified voltage. Each emission period includes: a first portion associated with a constant current level; and a second portion associated with a higher current level than the constant level, the second portion occurring before the first portion.

### BACKGROUND

1. Field

Exemplary embodiments relate to a light emitting diode (LED) luminescent apparatus, and, more particularly, to an alternating current (AC) LED luminescent apparatus and a driving method thereof.

2. Discussion of the Background

A light emitting diode (LED) is a semiconductor element that may be made of a material, such as gallium (Ga), phosphorus (P), arsenic (As), indium (In), nitrogen (N), aluminum (Al), etc. The LED may emit any suitable color, such as red, green, blue, etc., light when a current is applied. As compared with a fluorescent lamp, a conventional LED may have a relatively longer lifespan, a relatively faster response speed when excited (e.g., time until light is emitted after a current is initially applied), and a relatively lower power consumption. Due, at least in part, to these advantages, LED use is increasing. Accordingly, LEDs have found use in various kinds of luminescent devices, such as bulbs, tubes, recessed lights, down lights, street lamps, plane lights, etc.

Typically, an LED may be driven only via a direct current (DC) voltage due to the electrical characteristics of its diode. Accordingly, a luminescent apparatus using a conventional LED may be restricted in use and may include a separate circuit, such as a switched-mode power supply (SMPS) circuit, to enable use of an AC voltage that is typically available. In this manner, the circuitry of the luminescent apparatus may become relatively complicated, and, as such, the manufacturing cost of the luminescent apparatus may increase. Accordingly, research has been directed towards LEDs that can be driven at an AC voltage by connecting a plurality of light emitting cells in series or in parallel.

The above information disclosed in this Background section is only for enhancement of understanding of the background of the disclosure and therefore it may contain information that does not form the prior art that is already known in this country to a person of ordinary skill in the art.

### SUMMARY

Exemplary embodiments provide an AC LED luminescent apparatus including a plurality of light emitting groups driven sequentially with different emission periods. The emission periods are divided into two periods to apply the light emitting groups with a stable, constant current.

Additional aspects will be set forth in the detailed description which follows, and, in part, will be apparent from the disclosure, or may be learned by practice of the inventive concept.

According to exemplary embodiments, an alternating current (AC) light emitting diode (LED) luminescent apparatus includes a rectification unit configured to: receive an AC input; and output, via full-wave rectification, a rectified voltage; light emitting groups configured to sequentially receive the rectified voltage in association with corresponding emission periods; light emitting group driving units configured to respectively control current applied to the light emitting groups; and an LED driving integrated circuit configured to sequentially operate the light emitting groups based on voltage levels of the rectified voltage. Each emission period includes a first portion associated with a constant current level, and a second portion associated with a higher current level than the constant level, the second portion occurring before the first portion.

According to exemplary embodiments, an alternating current (AC) light emitting diode (LED) luminescent apparatus includes a rectification unit configured to receive an AC input and output, via full-wave rectification, a rectified voltage; and an LED driving integrated circuit configured to sequentially operate light emitting groups according to different emission periods based on voltage levels of the rectified voltage. Each of the different emission periods includes a first period in which a current over a threshold current level flows to a corresponding light emitting group of the light emitting groups and a second period in which a current flows to a corresponding light emitting group of the light emitting groups at the threshold current level.

A method of driving an alternating current (AC) light emitting diode (LED) luminescent apparatus, the method including: generating, via full-wave rectification, a rectified voltage based on an AC input and sequentially driving light emitting groups according to different emission periods based on voltage levels of the rectified voltage. Each of the different emission periods includes a first period in which a current over a threshold current level flows to a corresponding light emitting group of the light emitting groups; and a second period in which a current flows to a corresponding light emitting group of the light emitting groups at the threshold current level.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating a configuration of an AC LED luminescent apparatus, according to exemplary embodiments.

FIG. 2 is a waveform diagram illustrating waveforms of a rectified voltage and an LED driving current in the AC LED luminescent apparatus illustrated in FIG. 1, according to exemplary embodiments.

FIG. 3 is a schematic plan view illustrating a constant-current controlling unit in the AC LED luminescent apparatus illustrated in FIG. 1, according to exemplary embodiments.

FIG. 4 is a waveform diagram illustrating the waveform of an LED driving current supplied to the emission period A illustrated FIG. 2, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

According to exemplary embodiments, the term “light emitting group” refers to a group of LEDs (LED packages) connected in series, in parallel, or in series and in parallel in order to emit light in a luminescent apparatus. The term “light emitting group” may also refer to a group of LEDs whose operations are controlled as a unit (that is, turned on/off at the same time) under the control of a driving unit.

The term “threshold voltage level V_{TH}” refers to a voltage level to drive a single light emitting group. The term “threshold voltage level V_{TH1}” refers to a voltage level to drive a first light emitting group, and the term “threshold voltage level V_{TH2}” refers to a voltage level to drive a first light emitting group and a second light emitting group. When the threshold voltage level of the first light emitting group and the threshold voltage level of the second light emitting group are equal to each other, the second threshold voltage level V_{TH2} is 2V_{TH1}. As such, the term “n-th threshold voltage level V_{THn}” refers to a voltage level to drive the entire first to n-th light emitting groups.

The term “sequential driving method” refers to a driving method wherein the light emitting groups are sequentially turned on and turned off according to a voltage level of a rectified voltage generated by a full-wave rectifying AC voltage.

The term “LED drive IC” refers to an integrated circuit (IC) that controls the light emitting groups to be turned on and turned off according to a voltage level of a rectified voltage generated by a full-wave rectifying AC voltage, or according to a voltage level of an applied rectified voltage.

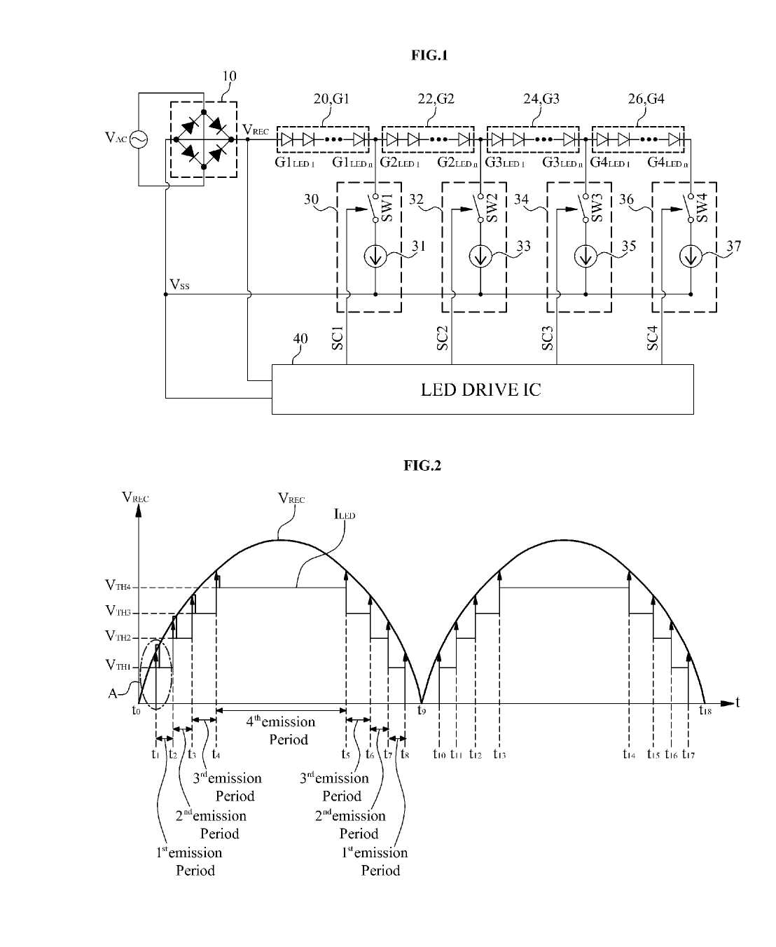

FIG. 1 is a block diagram illustrating a configuration of an AC LED luminescent apparatus, according to exemplary embodiments. FIG. 2 is a waveform diagram illustrating waveforms of a rectified voltage and an LED driving current in the AC LED luminescent apparatus illustrated in FIG. 1, according to exemplary embodiments.

According to exemplary embodiments, the AC LED luminescent apparatus includes light emitting groups connected in series or in parallel and that are sequentially driven by a constant-current rectified voltage. The light emitting groups include LEDs.

As seen in FIG. 1, the AC LED luminescent apparatus includes 4 groups, G1 to G4, but it is not limited thereto. Any suitable number of light emitting group may be utilized in association with exemplary embodiments described herein.

As illustrated in FIG. 1, the AC LED luminescent apparatus includes an AC power source V_{AC} and a rectification unit 10, which generates a rectified voltage (V_{REC}) by rectifying AC voltage supplied from the AC power source V_{AC}. The AC LED luminescent apparatus also includes a first light emitting group G1 (20), a second light emitting group G2 (22), a third light emitting group G3 (24), and a fourth light emitting group G4, (26), which are sequentially driven by utilizing the rectified voltage (V_{REC}). The AC LED luminescent apparatus also includes a LED drive integrated circuit (IC) 40, which controls the sequential driving of the light emitting groups G1 to G4 according to a voltage level of the rectified voltage (V_{REC}). The AC LED luminescent apparatus also includes a first light emitting group driving unit 30, a second light emitting group driving unit 32, a third light emitting group driving unit 34, and a fourth light emitting group driving unit 36, which have switching units SW1, SW2, SW3, SW4, respectively, and constant-current controlling units 31, 33, 35, and 37, respectively.

The AC power source V_{AC} may be a 220V power source, and the rectification unit 10 may include a half bridge or a full bridge, including LEDs (or diodes), so as to rectify the AC power source V_{AC}, but the configuration of rectification unit 10 is not limited thereto.

Among output voltages from the rectification unit 10, a first portion connected to the light emitting groups G1 to G4 has high potential and a second portion connected to the LED drive IC 40 has low potential. The low potential is shown as V_{SS} in FIG. 1 and may be a ground (GND).

The light emitting groups G1 to G4 each have LEDs connected in series or in parallel. For example, referring to FIG. 1, LEDs (G1_{LED1} . . . G1_{LEDn}) of the first light emitting group G1, LEDs (G2_{LED1} . . . G2_{LEDn}) of the second light emitting group G2, LEDs (G3_{LED1} . . . G3_{LEDn}) of the third light emitting group G3, and LEDs (G4_{LED1} . . . G4_{LEDn}) of the fourth light emitting group G4 may be connected serially.

The LEDs in each of the light emitting groups may be operated as one unit by the LED drive IC 40.

A closed loop may be formed between the rectification unit 10 and the LEDs (G1_{LED1} . . . G1_{LEDn}) of the first light emitting group G1 (20) by the switching unit SW1 in the first light emitting group driving unit 30. A current of a determined level may be constantly applied to the LEDs (G1_{LED1} . . . G1_{LEDn}) by the constant-current controlling unit 31 of the first light emitting group driving unit 30. That is, the first light emitting group driving unit 30 may include the first switching unit SW1 configured to form a closed loop between the rectification unit 10 and the first light emitting group G1 corresponding thereto. The first constant-current controlling unit 31 is configured to apply a constant current to the first light emitting group G1. The first constant-current controlling unit 31 may be electrically connected to the first light emitting group G1 after the first switching unit SW1 is turned on.

In a similar fashion, the second light emitting group driving unit 32 may include the second switching unit SW2 configured to form a closed loop between the rectification unit 10 and the second light emitting group G2 corresponding thereto. The second constant-current controlling unit 33 is configured to apply a constant current to the second light emitting group G2. The second constant-current controlling unit 33 may be electrically connected to the second light emitting group G2 after the second switching unit SW2 is turned on.

The third light emitting group driving unit 34 includes the third switching unit SW3 configured to form a closed loop between the rectification unit 10 and the third light emitting group G3 corresponding thereto. The third constant-current controlling unit 35 is configured to apply a constant current to the third light emitting group G3. The third constant-current controlling unit 35 may be electrically connected to the third light emitting group G3 after the third switching unit SW3 is turned on.

The fourth light emitting group driving unit 36 includes the fourth switching unit SW4 configured to form a closed loop between the rectification unit 10 and the fourth light emitting group G4 corresponding thereto. The fourth constant-current controlling unit 37 is configured to apply a constant current to the fourth light emitting group G4. The fourth constant-current controlling unit 37 may be electrically connected to the fourth light emitting group G4 after the fourth switching unit SW4 is turned on.

A process of driving the AC LED luminescent apparatus of FIG. 1 will be described with reference to FIG. 2.

The LED drive IC 40 determines the voltage level of the rectified voltage V_{REC} applied from the rectification unit 10, and sequentially drives the first light emitting group G1, the second light emitting group G2, the third light emitting group G3, and the fourth light emitting group G4 according to the voltage level of the rectified voltage V_{REC}.

Accordingly, in a first emission period during which the voltage level of the rectified voltage V_{REC} is equal to or greater than a first threshold voltage V_{TH1} and lower than a second threshold voltage V_{TH2} (t₁ to t₂ and t₇ to t₈ in one cycle of the rectified voltage V_{REC}), the LED drive IC 40 maintains the first switch SW1 in a turned-on state and maintains the second switch SW2, the third switch SW3, and the fourth switch SW4 in a turned-off state, such that only the first light emitting group 20 is driven.

In a second emission period during which the voltage level of the rectified voltage V_{REC} is equal to or greater than a second threshold voltage V_{TH2} and lower than a third threshold voltage V_{TH3} (t₂ to t₃ and t₆ to t₇ in one cycle of the rectified voltage V_{REC}), the LED drive IC 40 maintains the second switch SW2 in a turned-on state and maintains the first switch SW1, the third switch SW3, and the fourth switch SW4 in a turned-off state, such that only the first light emitting group 20 and the second light emitting group 22 are driven.

In a third emission period during which the voltage level of the rectified voltage V_{REC} is equal to or greater than a third threshold voltage V_{TH3} and lower than a fourth threshold voltage V_{TH4} (t₃ to t₄ and t₅ to t₆ in one cycle of the rectified voltage V_{REC}), the LED drive IC 40 maintains the third switch SW3 in a turned-on state and maintains the first switch SW1, the second switch SW2, and the fourth switch SW4 in a turned-off state, such that the first light emitting group 20, the second light emitting group 22, and the third light emitting group 24 are driven.

In a fourth emission period during which the voltage level of the rectified voltage V_{REC} is equal to or greater than a fourth threshold voltage V_{TH4} (t₄ to t₅ in one cycle of the rectified voltage V_{REC}), the LED drive IC 40 maintains the fourth switch S4 in a turned-on state and maintains the first switch SW1, the third switch S2 and the fourth switch SW3 in a turned-off state, such that each of the first light emitting group 20, the second light emitting group 22, the third light emitting group 24, and the fourth light emitting group 26 are driven.

That is, each of the first light emitting group 20, the second light emitting group 22, the third light emitting group 24, and the fourth light emitting group 26, corresponds to each of the first emission period (t₁ to t₂ and t₇ to t₈ in one cycle of the rectified voltage V_{REC}), the second emission period (t₂ to t₃ and t₆ to t₇ in one cycle of the rectified voltage V_{REC}), the third emission period (t₃ to t₄ and t₅ to t₆ in one cycle of the rectified voltage V_{REC}), and the fourth emission period (t₄ to t₅ in one cycle of the rectified voltage V_{REC}). The first to the fourth emission periods may vary in length.

Also, as shown in FIG. 2, each emission period may be divided into two periods having different current levels, which will be described later with reference to FIG. 4.

Each light emitting group may emit light in an emission period other than the emission period corresponding to the emission group. For example, the first light emitting group (G1) 20 may emit light during the entire first to the fourth emission periods since it emits light during t₁ to t₈ during one cycle of the rectified voltage V_{REC}. The second light emitting group G2 may emit light during t₂ to t₇; that is, from the second emission period to the fourth emission period. The third light emitting group G3 may emit light during t₃ to t₆; that is, the third and the fourth emission periods. The fourth light emitting group G4 may emit light during t₄ to t₅; that is, the fourth emission period. As such, a total emission period of each light emitting group may be different for each light emitting group.

According to exemplary embodiments, each of the light emitting groups may emit light having a same brightness during an emission period corresponding thereto, so that a static current (I_{LED}) having a constant level may be applied to the LEDs in each light emitting group. As such, and as shown in FIG. 1, the light emitting group driving units 30, 32, 34, and 36, which are configured to drive each light emitting group G1, G2, G3, and G4, respectively, may include the constant-current controlling unit 31, 33, 35, and 37, respectively.

The constant-current controlling units 31, 33, 3,5 and 37, as driving circuits of static current, protect the light emitting groups by applying a constant current having a level below the rated current to the light emitting group(s) during the associated emission periods.

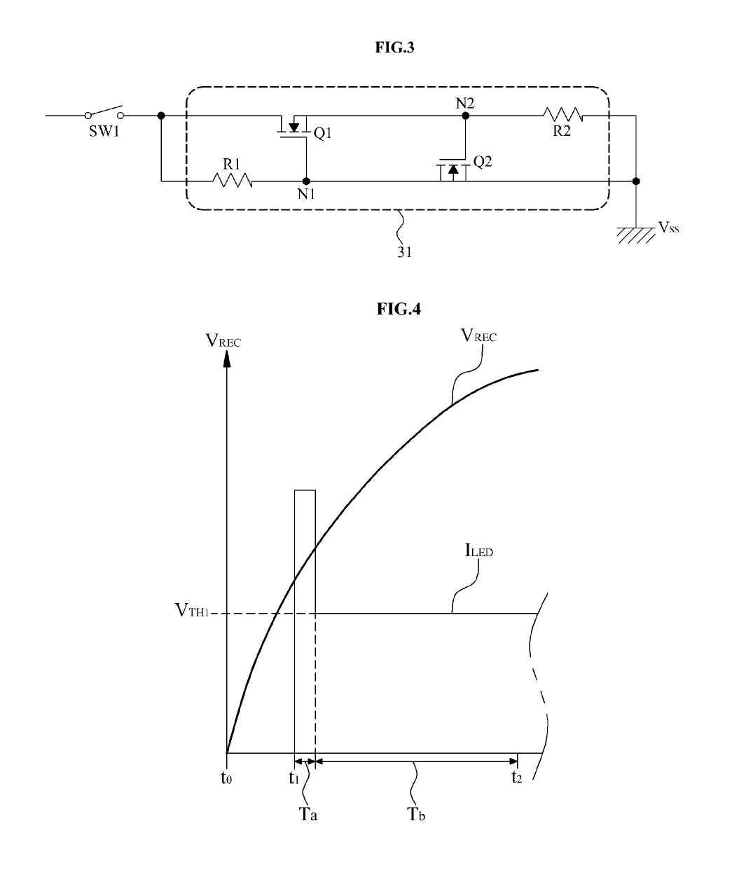

FIG. 3 is a schematic plan view illustrating an exemplary embodiment of a constant-current controlling unit of the AC LED luminescent apparatus illustrated in FIG. 1, according to exemplary embodiments.

The configuration of the constant-current controlling unit of FIG. 3 is purely exemplary embodiment, and is not limited thereto. For descriptive convenience, the structure of the first constant-current controlling unit 31 in the first light emitting group driving unit 30 will be described in detail with reference to FIG. 3. The structure of the other light emitting group driving units may be the same or different from the one described.

Referring to FIG. 3, the constant-current controlling unit 31 may include first and second switching elements Q1 and Q2, respectively, and first and second resistors R1 and R2, respectively.

A first (e.g., gate) electrode of the first switching element Q1 is coupled to a first node N1. A second (e.g., source) electrode of the first switching element Q1 is coupled to the switching unit SW1 of the first light emitting group driving unit 30. A third (e.g., drain) electrode of the first switching element Q1 is coupled to a second node N2.

A first (e.g., gate) electrode of the second switching element Q2 is coupled to the second node N2. A second (e.g., source) electrode of the second switching element Q2 is coupled to the first node N1. A third (e.g., drain) electrode of the second switching element Q2 is coupled to base voltage source Vss of the rectification unit 10.

The first and second switching elements Q1 and Q2, respectively, may be Field Effect Transistors (FETs), as shown in FIG. 3, however, any other suitable transistor (or other form of switching element) may be utilized in association with exemplary embodiments described herein.

The first resistor R1 is located between the first switching unit SW1 and the first node N1, and the second resistor R2 is located between the second node N2 and the base voltage source Vss of the rectification unit 10. That is, the first switching element Q1 may couple the switching unit SW1 to the second resistor R2, and the first (e.g., gate) electrode of the first switching element Q1 may be coupled to the third (e.g., drain) electrode of the second switching element Q2. The second switching element Q2 may couple the base voltage source Vss of the rectification unit 10 to the first resistor R1, and the first (e.g., gate) electrode of the second switching element Q2 may be coupled to the third (e.g., drain) electrode of the first switching element Q1.

Hereinafter, an exemplary operation of the first constant-current controlling unit 31 will be described with reference to FIG. 4.

When a voltage over the first threshold voltage V_{TH1} driving the first light emitting group G1 is applied, an operating condition of the first constant-current controlling unit 31 is satisfied. That is, when a current flows into the first light emitting group G1, the first resistor R1, which may be a pull-up resistor, applies a voltage to the gate electrode of the first switching element Q1 so that the first switching element Q1 is turned on, and the source/drain electrode of the first switching element Q1 are electrically coupled. A voltage proportional to a current flowing to the second resistor R2, which is connected to the drain electrode of the first switching element Q1, is generated. When the voltage between the both sides of the second resistor R2 reaches a certain voltage high enough to turn on the second switching element Q2, the second switching element Q2 is turned on and the source/drain electrode of the second switching element Q2 are electrically connected due to a voltage being applied to the gate electrode of the second switching element Q2.

According to exemplary embodiments, a voltage of the first node N1 decreases due to the electrical coupling of the source/drain electrodes of the second switching element Q2. That is, the second switching element Q2 is connected between the first node N1, which is coupled to one side of the first resistor R1, and the base voltage source Vss of the rectification unit 10. Accordingly, the first switching element Q1 is turned off, since the voltage of the first node N1 applied by the pull-up of the first resistor R1 decreases and the gate electrode of the first switching element Q1 is connected to the first node N1. In this manner, a current applied to the first light emitting group G1 may be maintained at a constant level, through the operation of the first constant-current controlling unit 31 as described above.

It is contemplated, however, that the structure of the constant-current controlling unit 31 shown in FIG. 3 is only exemplary, and any suitable constant-current controlling unit structure may be used in association with exemplary embodiments described herein. For example, the constant-current controlling unit 31 may be a current mirror circuit, such that the gate electrodes of the first and the second switching elements Q1 and Q2 are electrically connected to each other.

For the operation of the constant-current controlling unit 31, a closed loop may be formed between the rectification unit 10 and the LEDs (G1_{LED1} . . . G1_{LEDn}) in the first light emitting group G1 by the switching unit SW1 of the first light emitting group driving unit 30.

The first switching unit SW1 may be controlled by the LED drive IC 40. When the voltage level of the rectified voltage V_{REC} is in the first emission period, that is, the voltage level is equal to or greater than a first threshold voltage V_{TH1} and lower than a second threshold voltage V_{TH2}, the first switching unit SW1 is turned on by the LED drive IC 40.

A current, however, may be applied at a high level, that is, over the level of current previously set, due to an overshooting, and the like, when the first switching unit SW1 is turned on during an early emission period, including a starting point of the first emission period.

Exemplary embodiments provide an AC LED luminescent apparatus having light emitting groups driven sequentially with different emission periods. Emission periods may be divided into two periods including an early stage period (a first period) applied with a high level of current and a lasting period (a second period) applied with a current in a predetermined level. In this manner, a constant static current may be stably applied to the light emitting groups at a predetermined level, causing the LED luminescent apparatus to exhibit optical uniformity.

Each of the emission periods may be divided into two periods including an early stage period (a first period) applied with a high level current and a lasting period (a second period) applied with a current of a set level. This configuration will be described in detail with reference to FIGS. 1-4.

FIG. 4 is a waveform diagram illustrating the waveform of an LED driving current supplied to the emission period A illustrated FIG. 2, according to exemplary embodiments. The emission period A illustrated FIG. 2 corresponds to t₁ to t₂ in the first emission period. It is noted, however, that this is merely exemplary and the principles described may be applied to other emission periods.

Referring to FIG. 4, the first emission period includes a lasting period T_{b} (a first portion of the emission period) during which a constant current level is maintained, and a transient period Tₐ (a second portion of the emission period) before the lasting period, during which a current higher than the current maintained in the lasting period is applied. That is, a current flowing into the first light emitting group G1 during a lasting period T_{b} is a static current having a set current level determined by the first constant-current controlling unit 31. A current having a higher current level than the current level previously set as the lasting period T_{b} flows into the first light emitting group G1 during a transient period Tₐ.

Also, as shown in FIG. 4, the transient period Tₐ includes a starting point of the emission period, and the lasting period T_{b} follows the transient period Tₐ continuously. The lasting period T_{b} may apply to the entire emission period except for the transient period Tₐ. That is, although the first emission period is only illustrated as occurring during t₁ to t₂ in FIG. 4, the first emission period may also include t₇ to t₈ occurring after t₁ to t₂. As such, the lasting period T_{b} includes t₇ to t₈ after t₁ to t₂.

According to exemplary embodiments, the first light emitting group G1 may emit light during the first emission period due to operation of the first constant-current controlling unit 31 and the first switching unit SW1 of the first light emitting group driving unit 30. In this manner, the period during which the first switching unit SW1 is operated corresponds to the transient period Tₐ, and the period when the first constant-current controlling unit 31 is operated corresponds to the lasting period T_{b}. That is, when the voltage level of the rectified voltage V_{REC} output by the rectification unit 10 is in the first emission period, which is equal to or greater than a first threshold voltage V_{TH1} and lower than a second threshold voltage V_{TH2}, the first switching unit SW1 is turned on by the LED drive IC 40. It is noted, however, that a current may be applied at a high level, that is, over the level of current previously set, due to a cause, such as an overshooting, and the like, when the first switching unit SW1 is turned on during an early emission period, including a starting point of the first emission period. That is, the period during which the first switching unit SW1 is turned on and operated corresponds to the transient period Tₐ, and a high level current, that is, a current having a level over the level of the static current of lasting period T_{b}, may flow during the transient period Tₐ.

If the first constant-current controlling unit 31 operates during the transient period Tₐ, issues, such as overheating, may occur in the circuitry of the first constant-current controlling unit 31. Thus, according to exemplary embodiments, adjustments in the period when the first switching unit SW1 is operated corresponds to the transient period Tₐ.

A closed loop between the rectification unit 10 and the LEDs (G1_{LED1} . . . G1_{LEDn}) of the first light emitting group G1 is formed by the switching unit SW1 of the first light emitting group driving unit 30 according to operation of the first switching unit SW1. In this manner, the first constant-current controlling unit 31 may operate. To this end, the period when the first constant-current controlling unit 31 is operated corresponds to the lasting period T_{b}. That is, a static current may be stably applied to the first light emitting group G1 with a constant-current at a set level because the period during which the first constant-current controlling unit 31 operates does not overlap with the transient period Tₐ when a high level current flows.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An alternating current (AC) light emitting diode (LED) luminescent apparatus, comprising:
a rectification unit configured to:
receive an AC input; and
output, via full-wave rectification, a rectified voltage;
light emitting groups configured to sequentially receive the rectified voltage in association with corresponding emission periods;
light emitting group driving units configured to respectively control current applied to the light emitting groups; and
an LED driving integrated circuit configured to sequentially operate the light emitting groups based on voltage levels of the rectified voltage;
wherein each emission period comprises:
a first portion associated with a constant current level; and
a second portion associated with a higher current level than the constant level, the second portion occurring before the first portion.

2. The AC LED luminescent apparatus of claim 1, wherein each light emitting group driving unit comprises:
a switching unit configured to form an electrically closed loop between the rectification unit and a corresponding light emitting group of the light emitting groups; and
a constant-current controlling unit configured to maintain a constant current through the light emitting group, the constant-current controlling unit being electrically connected to the corresponding light emitting group via the switching unit.

3. The AC LED luminescent apparatus of claim 1, wherein:
each of the light emitting groups comprises a plurality of LEDs electrically connected in series, in parallel, or in series and in parallel; and
the plurality of LEDs in each of the light emitting groups is operated as one unit via the LED driving integrated circuit.

4. The AC LED luminescent apparatus of claim 1, wherein the second portion of an emission period comprises a starting point of the emission period.

5. The AC LED luminescent apparatus of claim 4, wherein the first portion follows the second portion continuously.

6. The AC LED luminescent apparatus of claim 2, wherein the LED driving IC is configured to enable operation of the constant-current controlling unit during the first portion.

7. The AC LED luminescent apparatus of claim 6, wherein the LED driving integrated circuit is configured to operate the switching unit during the second portion.

8. The AC LED luminescent apparatus of claim 7, wherein operation of the switching unit and operation of the constant-current controlling unit are mutually exclusive.

9. An alternating current (AC) light emitting diode (LED) luminescent apparatus, comprising:
a rectification unit configured to:
receive an AC input; and
output, via full-wave rectification, a rectified voltage; and
an LED driving integrated circuit configured to sequentially operate light emitting groups according to different emission periods based on voltage levels of the rectified voltage,
wherein each of the different emission periods comprises:
a first period in which a current over a threshold current level flows to a corresponding light emitting group of the light emitting groups; and
a second period in which a current flows to a corresponding light emitting group of the light emitting groups at the threshold current level.

10. The AC LED luminescent apparatus of claim 9, wherein the apparatus further comprises:
light emitting group driving units, each of the light emitting group driving units comprising:
a switching unit configured to form an electrically closed loop between the rectification unit and the light emitting group corresponding thereto; and
a constant-current controlling unit configured to maintain a constant current through the light emitting group, the constant-current controlling unit being electrically connected to the corresponding light emitting group via the switching unit.

11. The AC LED luminescent apparatus of claim 9, wherein:
each of the light emitting groups comprises a plurality of LEDs electrically connected in series, in parallel, or in series and in parallel; and
the plurality of LEDs in each of the light emitting groups is operated as one unit via the LED driving integrated circuit.

12. The AC LED luminescent apparatus of claim 9, wherein the first period comprises a starting point of the emission period.

13. The AC LED luminescent apparatus of claim 12, wherein the second period occurs after the first period.

14. The AC LED luminescent apparatus of claim 10, wherein the LED driving integrated circuit is configured to operate the switching unit during the first period.

15. The AC LED luminescent apparatus of claim 10, wherein the LD driving integrated circuit is configured to operate the constant-current controlling unit during the second period.

16. A method of driving an alternating current (AC) light emitting diode (LED) luminescent apparatus, the method comprising:
generating, via full-wave rectification, a rectified voltage based on an AC input; and
sequentially driving light emitting groups according to different emission periods based on voltage levels of the rectified voltage,
wherein each of the different emission periods comprises:
a first period in which a current over a threshold current level flows to a corresponding light emitting group of the light emitting groups; and
a second period in which a current flows to a corresponding light emitting group of the light emitting groups at the threshold current level.

17. The method of driving the AC LED luminescent apparatus of claim 16, wherein the first period comprises a starting point of the emission period.

18. The method of driving the AC LED luminescent apparatus of claim 17, wherein the second period follows the first period continuously.

19. The method of driving the AC LED luminescent apparatus of claim 16, wherein sequentially driving the light emitting groups comprises:
driving a first light emission group during a first emission period;
driving the first and a second light emission group during a second emission period;
driving the first, the second, and a third light emission group during a third emission period; and
driving the first, the second, the third, and a fourth light emission group during a fourth light emission period.

20. The method of driving the AC LED luminescent apparatus of claim 16, wherein sequentially driving the light emitting groups comprises:
forming a closed loop between the rectification unit and at least one of the light emitting groups when the rectified voltage and the voltage level are within a determined range; and
maintaining a constant-current through the at least one light emitting group after the closed loop is formed.

21. The method of driving the AC LED luminescent apparatus of claim 20, wherein forming the closed loop occurs during the first period.

22. The method of driving the AC LED luminescent apparatus of claim 20, wherein maintaining the constant-current occurs during the second period.
